(19) United States
(12) Patent Application Publication
(10) Pub. No.: US 2013/0316580 A1
(43) Pub. Date: Nov. 28, 2013

(54) MAGNETIC SHIELDING FOR BUS SYSTEMS

(71) Applicants: Jochen Huebl, Schwieberdingen (DE); Roland Mager, Offenau (DE); Peter Kralicek, Marbach (DE)

(72) Inventors: Jochen Huebl, Schwieberdingen (DE); Roland Mager, Offenau (DE); Peter Kralicek, Marbach (DE)

(21) Appl. No.: 13/989,227

(22) PCT Filed: Nov. 16, 2011
(86) PCT No.: PCT/EP2011/070210

§ 371 Date: Aug. 14, 2013

(30) Foreign Application Priority Data
Nov. 24, 2010 (DE) 10 2010 061 849.7

(51) Int. Cl. H01R 13/658

(52) U.S. Cl. CPC H01R 13/658
USPC 439/607.01

(57) ABSTRACT

A plug system for a high-speed bus system, having a first terminal element and a second terminal element. The first terminal element and the second terminal element each have a plurality of contact elements. The first terminal element and the second terminal element are connectable in such a way that individual contact elements of the first terminal element and the second terminal element may each be conductively contacted to one another. A data signal to be shielded is connectable to at least one first contact element of the first and/or second terminal element. At least two second contact elements in the first terminal element and/or second terminal element are situated adjoining the at least one first contact element. The plug system is characterized in that the at least two second contact elements are conductively connected in the first terminal element and in the second terminal element.

### FIELD

The present invention relates to bus systems in vehicles. In particular, the present invention relates to the connection of bus systems to motor vehicle control units having magnetic and/or electrical shielding in a terminal plug element.

### BACKGROUND INFORMATION

The wiring in motor vehicles is typically implemented using a bus system. A plurality of control units are electrically connected to one another via a shared bus. The control units exchange data or information with one another and/or control components of the vehicle while using the bus. For example, the CAN bus system or the Flexray bus system is used for this purpose.

From a centrally installed wiring harness, individual control units are connected using plugs or sockets situated in/on the wiring harness. The control units each have complementary sockets or plugs, which are configured to connect the bus system to the control unit.

In control units, in particular in motor vehicle control units, plug pins of a corresponding terminal plug, which typically lie parallel or aligned to one another, are guided or molded or embedded in the plug/in the socket.

The wiring of a corresponding control unit may have, on the one hand, (low-speed) signal and/or supply lines, for example, supply lines for a voltage supply of the control unit and, on the other hand, high-speed data lines.

For high-speed bus systems, special wave-resistance-adapted and shielded plugs are typically used. However, appropriate plugs typically significantly increase the costs of a bus system. Due to the high cost pressure, these special plugs are often omitted and the signals of the high-speed bus are conducted via simple plug pins into a control unit.

However, the plugs which are typical in the automotive field, for example, are normally designed as inlaid parts guided in chambers lying in parallel, which extend up to a circuit board or are only molded or embedded in the plug.

If many parallel lines are present in a system, the risk of cross-coupling with neighboring lines exists. In order to counteract this cross-coupling, for example, in the case of high-speed bus systems, the corresponding associated conductors in the wiring harness are embodied as twisted up to the plug, as a so-called “twisted pair.”

This twisting is suspended from the point at which the cables merge into the plug or the socket, however. For example, lines to which rapid signals are applied are again guided (or embodied) lying parallel to one another in the plug and in particular lying adjacent to other lines. Cross-coupling may subsequently occur thereon. Such cross-coupling may induce an interfering signal in the lines situated in parallel; the lines may then contribute to increased electromagnetic emissions of the control unit.

Conventional plugs which counteract a corresponding coupling are implemented as plugs which have been developed under high-frequency aspects, for example, having complete shielding using high-frequency shield elements, e.g., high-frequency plates, and may therefore result in higher costs.

Alternatively, pins are not used close to the high-speed bus system, therefore the distance of other lines to the bus system is increased, so that no or reduced cross-coupling occurs. In the second case, however, the efficiency of a plug system is decreased due to an incomplete configuration.

### SUMMARY

According to one aspect of the present invention, electromagnetic emissions of a control unit are reduced and, for this purpose, cross-coupling in a bus system on adjacent lines are reduced without the use of special high-frequency-optimized plug systems.

One object of the present invention is therefore that normal plugs, which are typical in the automotive field, may continue to be used and in particular a closed shield or shielding does not have to be placed around a high-speed signal. Couplings on adjacent lines to the data lines of the high-speed bus system are damped by targeted attenuation of an electromagnetic field which originates from the bus system. Lower emission values may thus be achieved.

The present invention uses in particular the effect of a countercurrent induction in a conductor loop, which is situated directly around the data line(s) of a high-speed bus, for example. A corresponding conductor loop may be implemented, for example, in that plugs or plug pins used in a plug system or lines which are situated directly adjacent to the lines of the high-speed bus are connected or wired to one another in such a way that they form the desired conductor loop.

A typical plug system for a control unit is usually constructed from two terminal elements, which are situated on the control unit, on the one hand, and are connected to the wiring harness of the bus system, on the other hand. The first and second terminal elements may thus be, for example, a plug situated in or on the housing of the control element and a socket situated on the wiring harness. Plugs or sockets have internal lines, for example, plug pins, which may ultimately be considered to be conductors extending in parallel in the plug.

A terminal element does not necessarily have to be considered to be a compact element in this case, which allows a plurality of electronic contacts to be produced in one plug-in procedure, for example. It is also possible that a terminal element simply includes a plurality of individual contact elements, which are plugged onto pins of the particular other terminal element, for example.

The data signal to be shielded is conducted, depending on its embodiment, via at least one first contact element through the first and second terminal elements, whereby bus system and control unit are connectable to one another. In the case of the use of a twisted high-speed data line, for example, configured as a “twisted pair,” two first contact elements may be used, for example.

The bus system therefore has the twisted high-speed data line in the wiring harness, for example, which merges in the two terminal elements into lines or plug pins extending in parallel. The second contact elements may therefore be those plug pins which are guided directly adjacent to the plug pins of the high-speed data line in the two terminal elements.

These plug pins situated directly adjacent to the contact element(s) of the high-speed data signal may be used to form the conductor loop. These second contact elements, at least two second contact elements, may be conductively connected to one another at both ends of the lines extending in parallel in the terminal elements. A conductor loop therefore generally results, which encloses the parallel guided conductor or conductors of the high-speed data signal in the terminal elements. The conductor loop may furthermore also be connected to ground or formed by ground on at least one side, for example, on the side of the control unit.

In other words, the conductor loop results in that at least two second contact elements in the first terminal element and in the second terminal element are conductively connected to one another. The conductor loop preferably completely encloses the parallel guided lines of the high-speed data line in this case.

The effect of the attenuation of the magnetic field of the high-speed data line results in that the plug pins are electrically conductively connected adjacent to those of the high-speed bus and therefore form the described conductor loop, so that a countercurrent is inducible therein. In order that this current may flow, the pins of the second contact elements must be connected on both sides. A corresponding effect similarly results in the case in which first and second terminal elements have full shielding, and therefore the second contact elements are enclosed using a plate, for example, therefore a conductive material. The second contact elements may also use this conductive material to form the conductor loop.

The conductive connection may be established, on the one hand, by a dedicated connection of the two second contact elements, or these may only be connected to ground, for example, and thus form the conductor loop. However, a conductor loop may similarly be formed independently of ground.

In the case of a conductor loop disconnected from ground, therefore a conductor loop which is exclusively closed in itself, a magnetic shielding may essentially be established, while additionally, in the case in which the second contact elements are connected to ground, an attenuation of an electrical field may similarly still be implementable.

A conductive connection of contact elements may be established, for example, using so-called coding bridges in the plug or in the socket.

The present invention therefore allows, for example, damping of approximately 6 dB or more in the other arranged neighboring pins and may be achieved very cost-effectively, since only the adjacent pins in the device must be connected to ground. An above-mentioned bridge may be used in the plug.

The at least one first contact element, also in the case in which at least two first contact elements are used, for example, for a twisted pair data connection, and the at least two second contact elements may preferably be situated essentially in a plane. A type of two-dimensional shielding may thus be formed.

Further contact elements for the shielding, therefore to form a second conductor loop, for example, at least two third contact elements, may in contrast be situated in such a way that the third contact elements also generally enclose the at least one contact element, which is therefore situated between the two third contact elements, and thus form a second plane, this second plane being perpendicular to the plane which is formed by the first and second contact elements, for example.

Further, fourth, fifth, etc., contact elements may be provided, which form further planes together with the first contact element and enclose it, so that the successive planes are also situated at a certain angle, for example, 45° or 22.5°, to the first and second planes. A further preferred shielding of the at least one first contact element may thus be formed.

One embodiment is particularly preferred in this case, according to which all contact elements which enclose the at least one first contact element are designed as the conductor loop, and are therefore at least partially conductively connected to one another.

Exemplary embodiments of the present invention are shown in the figures and explained in greater detail below.

### BRIEF DESCRIPTION OF THE DRAWINGS

FIG. 1 shows an exemplary embodiment of a plug of a control unit.

FIGS. 2a, b show a schematic view and an associated field distribution, which is calculated by simulation, of an exemplary embodiment of a plug system.

FIGS. 3a, b show a schematic view and an associated field distribution, which is calculated by simulation, of an exemplary embodiment of a plug system according to the present invention.

### DETAILED DESCRIPTION OF EXAMPLE EMBODIMENTS

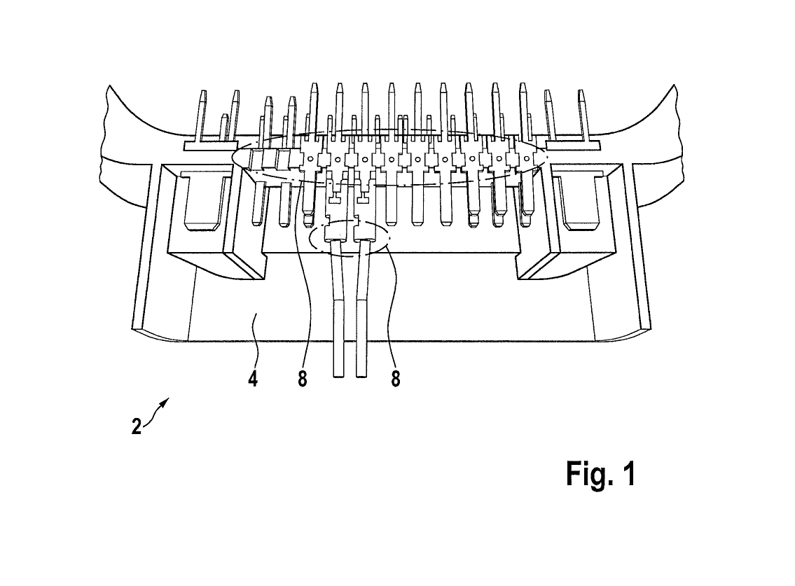

FIG. 1 shows an exemplary embodiment of a plug system 2, for example, an automobile plug of an ESP control unit.

Plug system 2 according to FIG. 1 is open in the middle, so that the individual contact elements 8 are visible. The plug is designed as an example in such a way that it may be attached, for example, soldered with the upwardly oriented side directly onto a printed circuit board or circuit board of a control unit.

Plug contacts or contact elements 8, which are oriented downward in FIG. 1, represent the terminals protruding away from the control unit in this case. A second terminal element 6 may be attachable to first terminal element 4, which generally simultaneously conductively connects or couples all contact elements 8 or, as is apparent in FIG. 1, individual contact elements 8 may be individually contacted using plug pins.

Two lines are connected to the two plug pins shown as an example. As is apparent in FIG. 1, no explicit magnetic and/or electromagnetic shielding of the plug is provided.

In the case in which the two illustrated lines of the plug pins represent a high-speed data line, it would induce magnetic and/or electromagnetic interference in adjacent contact elements 8 due to the parallel guiding in first terminal element 4.

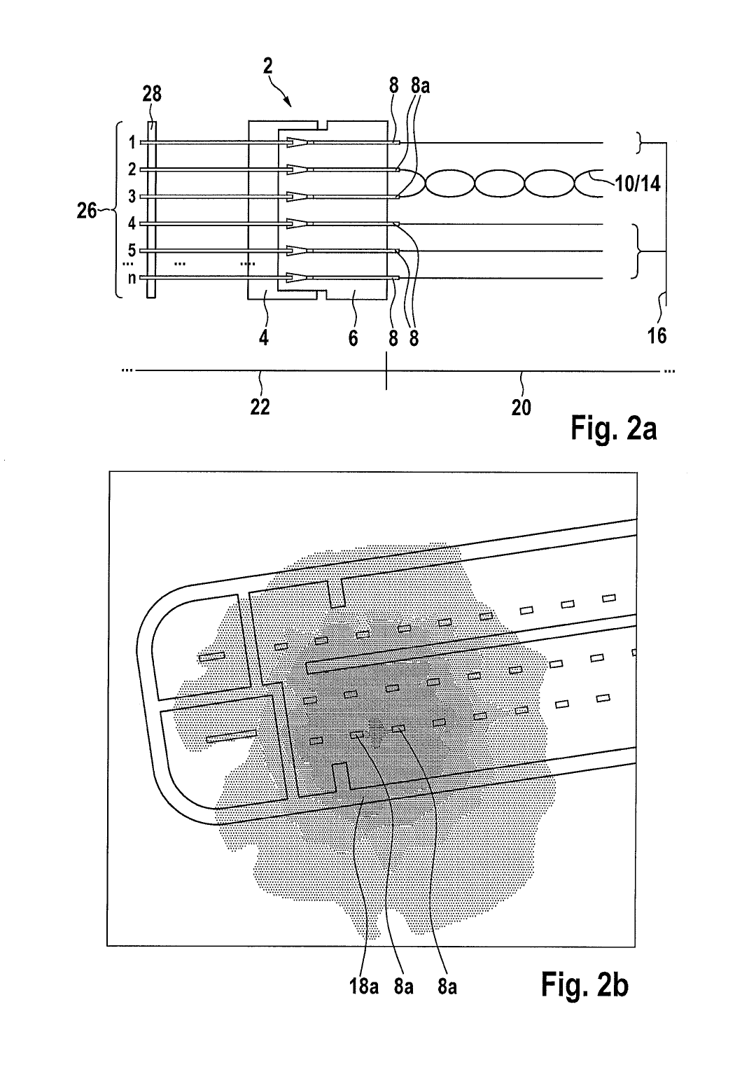

Such wiring or such a plug system 2 is schematically shown in FIG. 2a.

As an example, a total of four signal or supply lines 16 (pins 1, 4, 5, n) are shown and one high-speed data line 14 (pins 2, 3), which conducts a data signal 10 to be shielded.

In cable area 20, the shielding takes place by twisting high-speed data line 14, shown as successive line loops of high-speed data line 14.

In plug area 22 in control unit 26, however, because exclusively linear lines are provided in the plug housing, a twisted design of high-speed data line 14 is no longer possible. Therefore, a magnetic or electromagnetic load on surrounding lines (pins 1, 4, 5, . . . , n) results through parallel guided lines (pins 2 and 3) of high-speed data line 14 in plug area 22.

A section through plug system 2 is shown in FIG. 2b, in particular through parallel guided contact elements 8. A high-speed data connection 14 is shown connected as an example to contact elements 8a in this case. A magnetic field H 18a, which is shown shaded in FIG. 2b, is generated by contact elements 8a, which are guided in parallel in the plug itself.

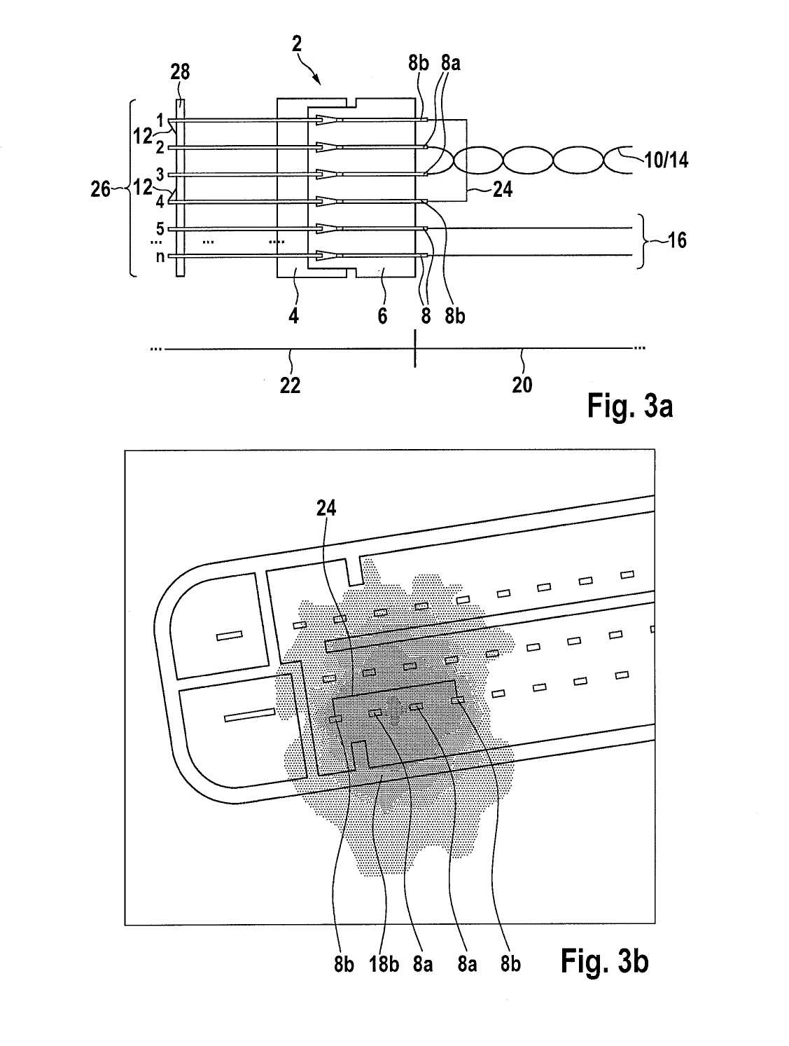

Furthermore, with reference to FIG. 3a, a schematic view and an associated field distribution, which is calculated by simulation, of a plug system according to the present invention are shown.

Plug system 2 according to FIG. 3a corresponds generally in this case to plug system 2 according to FIG. 2a.

In contrast to FIG. 2a, however, in plug system 2 according to FIG. 3a, contact elements 8b adjacent to twisted high-speed data line 14 are bridged using a bridge element 24. A comparable bridge element may be produced on printed circuit board 28 situated in control unit 26; alternatively, particular contact elements 8b in control unit 26, for example, on printed circuit board 28, may be connected to ground 12. Via the second bridge element (not shown) or via the connection to ground 12, a conductor loop is constructed in contact elements 8b (pins 1 and 4), which may be used for shielding a magnetic field H. In the case in which a conductor loop is not exclusively formed, but rather contact elements 8b are also (additionally) connected to ground 12, an electrical field E may also be reduced.

FIG. 3b shows the effect of a conductor loop which reduces a magnetic field H 18b, which is caused by contact elements 8a of high-speed data line 14. Contact elements 8b are conductively connected to one another in this case and form a conductor loop according to the present invention.

The field distribution according to FIGS. 2b and 3b was calculated by simulation.

FIGS. 2b and 3b show the distribution of the magnetic field in a sectional plane through the plug. It is clearly apparent in the comparison of FIG. 2b to FIG. 3b that magnetic field 18a extends further into the plug or to the surrounding adjacent pins than magnetic field 18b.

The interference of adjacent pins may thus be reduced by using a conductor loop.

1-7. (canceled)

8. A plug system for a high-speed bus system, comprising:
a first terminal element; and
a second terminal element, the first terminal element and the second terminal element each having a plurality of contact elements, the first terminal element and the second terminal element being configured to be connectable to one another in such a way that individual contact elements of the first terminal element and the second terminal element may each be electrically conductively contacted to one another, a data signal to be shielded being connectable to at least one first contact element of at least one of the first terminal element and the second terminal element, and at least two second contact elements in at least one of the first terminal element and the second terminal element being situated adjoining the at least one first contact element on both sides, wherein the at least two second contact elements in the first terminal element and in the second terminal element are conductively connected.

9. The plug system as recited in claim 8, wherein the at least two second contact elements at least one of in the first terminal element, and in the second terminal element, are connected to ground.

10. The plug system as recited in claim 8, wherein a twisted high-speed data line is connectable to the at least two of the first contact elements.

11. The plug system as recited in at claim 8, wherein the at least one of the first contact element and the at least two second contact elements are situated in a plane.

12. The plug system as recited in claim 8, further comprising:
at least two third contact elements, wherein the at least two third contact elements in the first terminal element and in the second terminal element are at least one of conductively connected and are connected to ground, and the at least two third contact elements are not situated in the plane of the at least one first contact element, and the at least two second contact elements are situated perpendicularly to the plane.

13. The plug system as recited in claim 8, wherein all of the contact elements enclosing the at least one first contact element, are, at least one of: i) at least partially, conductively connected to one another in the first terminal element and in the second terminal element, and ii) connected to ground.

14. A control unit for a vehicle, comprising a first terminal element to which a second terminal element is connectable, wherein the first terminal element and the second terminal element form a plug system for a high-speed bus system, the first terminal element and the second terminal element each having a plurality of contact elements, the first terminal element and the second terminal element being configured to be connectable to one another in such a way that individual contact elements of the first terminal element and the second terminal element may each be electrically conductively contacted to one another, a data signal to be shielded being connectable to at least one first contact element of at least one of the first terminal element and the second terminal element, and at least two second contact elements in at least one of the first terminal element and the second terminal element being situated adjoining the at least one first contact element on both sides, wherein the at least two second contact elements in the first terminal element and in the second terminal element are conductively connected.
